(19) United States
(12) Patent Application Publication
(10) Pub. No.: US 2014/0068441 A1
(43) Pub. Date: Mar. 6, 2014

(54) TYPETELL TOUCH SCREEN KEYSTROKE ANNOUNCER

(71) Applicant: E. Dewayne Robbins, Utopia, TX (US)

(72) Inventor: E. Dewayne Robbins, Utopia, TX (US)

(21) Appl. No.: 13/965,323

(22) Filed: Aug. 13, 2013

Related U.S. Application Data
(60) Provisional application No. 61/693,908, filed on Aug. 28, 2012.

(51) Int. Cl. G06F 3/16; G06F 3/0481; G06F 3/0488

(52) U.S. Cl. CPC G06F 3/167; G06F 3/04886; G06F 3/04817
USPC 715/727

(57) ABSTRACT

A method for validating a touch made on a touch-sensitive screen such as, for example, making a keystroke on a screen keyboard on a computing device with a touch-sensitive screen (such as a smart phone or a tablet computer). The user intends to make an intended single touch on a desired zone on the screen, and then touches an actually-touched zone on the screen. The actual touch may or may not be on the zone desired by the user. The computing device initiates, in real time, an audible response corresponding to the actual touch (such as a real time announcement of the keystroke actually made). The user can thus validate that as she types, each keystroke she makes is accurate, one by one, “on the fly”. Software embodying the method may be available in any form, such as embedded in an operating system or downloadable as a separate app.

### RELATED APPLICATIONS

This application claims the benefit of, and priority to, U.S. Provisional Application Ser. No. 61/693,908, filed Aug. 28, 2012.

### FIELD OF THE INVENTION

The disclosure of this application is related generally to software that enables computers to announce back keystrokes as they are made, and more specifically to such software that executes on computers that receive user input via touch-sensitive screens.

### BACKGROUND

Software applications that announce audibly a keystroke “on the fly”, as the keystroke is made, are known in the art. For example, functionality in NVDA open source software assists the sight-impaired by announcing, audibly and phonetically, the keystroke that has just been made. Thus, as the sight-impaired operator types, for example, the word “welcome”, the computer announces audibly back to the operator, keystroke by keystroke as she types, the sounds “Double-You; Eee; Ell, See; Oh; Em; Eee”. The operator's keystroke accuracy is thus validated by the computer as she types.

The prior art has directed this software functionality exclusively to validating keystroke accuracy on conventional keyboards, in which each key is a separate, independently movable structure capable of moving when pressed. The advent of smart phones and tablet computers has brought in a generation of keyboards where the keys are separate, touch-sensitive areas or zones on a touch-sensitive screen. Instead of pressing a movable key, the operator touches or “taps” the screen in the designated zone in order to make a keystroke.

Miniaturization of these computing and phone devices necessarily requires smaller and higher-resolution touch screens. As the screens get smaller, the keyboards get correspondingly smaller, and the touch zones for each key get smaller. The keyboards can often be more conveniently and quickly operated with two thumbs rather than with all fingers and thumbs on both hands, as on conventional “pressed” keyboards.

This transition in data entry techniques via increasingly smaller touch-sensitive keyboards brings about a potential for increasing keystroke inaccuracy. The transition calls for delivering an increasingly precise touch with a finger or thumb, often when the keyboard is so small that the operator cannot see the desired touch zone (or others around it) as the finger or thumb is touched to the screen.

As a result, keystroke accuracy and typing fluency suffers. All but the most skilled operators commit frequent keystroke errors on these increasingly small touch screen keyboards, causing the “ordinary” operator to have to go back frequently and correct erroneous keystrokes. In addition to the time spent correcting keystrokes, the process of type-and-correct further impairs typing fluency. There is therefore a need in the art for “TypeTell” keystroke announcer functionality for touch screen keyboards in order to validate keystroke accuracy “on the fly” when the touch zones for each key become so small that all operators, whether sight-impaired or not, have difficulty typing fluently and accurately.

### SUMMARY AND TECHNICAL ADVANTAGES

Software is provided, executable on computing devices having touch screens (such as, for example, smart phones or tablets), where the software's functionality announces, audibly and phonetically, a keystroke “on the fly” as it is typed on a touch-sensitive keyboard. The software may be embedded in the computing device's operating system, or alternatively may be added later as a downloadable application (known colloquially as an “app”). Regardless of how it is introduced into and deployed on the computing device, however, the software and its associated functionality is advantageously made available to all applications running on the computing device in which a touch-sensitive keyboard may be called up by the operator.

In another aspect, a method is provided for validating a touch made on a touch-sensitive screen such as, for example, making a keystroke on a screen keyboard on a computing device with a touch-sensitive screen (such as a smart phone or a tablet computer). The user intends to make an intended individualized touch on a desired zone on the screen, and then touches an actually-touched zone on the screen. The actual touch may or may not be on the zone desired by the user. The computing device initiates, in real time, an audible response corresponding to the actual touch (such as a real time announcement of the keystroke actually made). The user may thus validate that as she types, each keystroke she makes is accurate, one by one, “on the fly”. Software embodying the method may be available in any form, such as embedded in an operating system or downloadable as a separate app.

In another aspect, the TypeTell software comprises a set of computer-executable instructions suitable to be persistently stored on a non-transitory computer-readable storage medium. The set of instructions, when executed, causes a computer processor programmed by the set of instructions to perform a method. The computer processor runs an operating system, and is instructed via a user interface that includes a touch-sensitive screen. The method comprises the steps of: (a) receiving information that a uniquely-identifiable zone on the touch-sensitive screen has been activated via a touch; (b) matching the uniquely-identifiable zone to a designated audible response previously associated with the identifiable zone; and (c) causing a sound media player to announce the designated audible response in real time with step (a).

In another aspect, the TypeTell software comprises a set of computer-executable instructions suitable to be persistently stored on a non-transitory computer-readable storage medium. The set of instructions, when executed, causes a computer processor programmed by said set of instructions to perform a method. The computer processor runs an operating system and is instructed via a user interface that includes a touch-sensitive screen. The method comprises the steps of: (a) receiving information that a uniquely-identifiable zone on the touch-sensitive screen has been activated via a touch; (b) recognizing the uniquely-identifiable zone as a key on a screen keyboard on the touch-sensitive screen; (c) matching the key to a designated audible response previously associated with the key, the designated audible response comprising an announcement of a keystroke corresponding to the key according to a pre-ordained keyboard convention; (d) causing a sound media player to announce the designated audible response in real time with step (a). The pre-ordained keyboard convention may correspond to any human-readable language. Alternatively the pre-ordained keyboard convention may correspond to one of multiple keyboard conventions within a single human-readable language, such as British or American keyboard conventions within the English language.

It is therefore a technical advantage of the TypeTell keystroke announcer to assist keystroke accuracy and typing fluency on a touch-screen keyboard, especially when the touch zones provided on the keyboard for an individual keystroke are small. The software enables the computing device to announce each keystroke “on-the-fly”, as (or very shortly after) the keystroke is made, confirming to the operator that the keystroke made was the one intended.

A presently preferred embodiment of the software is suitable to be deployed on an Apple iPhone. It will be clearly understood, however, that such a presently preferred embodiment is chosen purely for exemplary and illustrative purposes only, and that the scope of this disclosure is expressly not limited to iPhone deployments. It will be understood that the TypeTell software and its functionality disclosed herein are generally suitable to be deployed on any computing device with a touch-sensitive keyboard available on a touch-sensitive screen.

Referring now to the presently preferred iPhone embodiment, touch-sensitive keystroke zones on its text messaging keyboard, just for example, are approximately 4 mm×6 mm when the iPhone screen is in portrait orientation. This size is typical of a small keystroke zone in which the TypeTell software and functionality are advantageous to assist keystroke accuracy and typing fluency. Other keystroke zones on other applications and functions on the iPhone (and/or on other computing devices) may be larger or smaller than this, and the scope of this disclosure is not limited to any particular keystroke zone size on a touch-sensitive screen. The point is that the TypeTell software and its associated functionality are advantageous to assist keystroke accuracy and typing fluency especially when the keystroke zone is small, and the 4 mm×6 mm zones on the iPhone as described above are a good example of such small keystroke zones to which TypeTell is advantageous.

Another technical advantage of the TypeTell software is that its functionality is operable to assist with keystroke accuracy and typing fluency for the sight impaired, as well as those whose sight is satisfactory but who are just poor typists on small keyboards on touch-sensitive screens.

A further technical advantage of the TypeTell software is that its functionality need not be limited to English language characters with associated audible keystroke playback in the English language. TypeTell may be easily configured to be operable, according to user selection, on any character set keyed and announced back in any language.

The foregoing has outlined rather broadly the features and technical advantages of the inventive disclosure of this application, in order that the detailed description of the embodiments that follows may be better understood. It will be appreciated by those skilled in the art that the specific embodiments disclosed may be readily utilized as a basis for modifying or designing other structures for carrying out the same general purposes of the inventive material set forth in this disclosure.

### BRIEF DESCRIPTION OF THE DRAWINGS

For a more complete understanding of embodiments described in detail below, and the advantages thereof, reference is now made to the following drawings, in which:

FIG. 1 is a representation of an iPhone screen in the Keyboard preferences menu; and

FIGS. 2, 3, and 4 are representations of an iPhone screen in the Messaging application.

### DETAILED DESCRIPTION

As noted above, a presently preferred embodiment of the TypeTell software and functionality is embodied on an iPhone; however, the scope of this disclosure is expressly not limited to such an embodiment. For illustrative purposes only, the following description (and associated figures) assume that the TypeTell software has been deployed on an iPhone, either as a factory-installed feature in the original iOS operating system, or as an upgrade via, for example, a downloaded app.

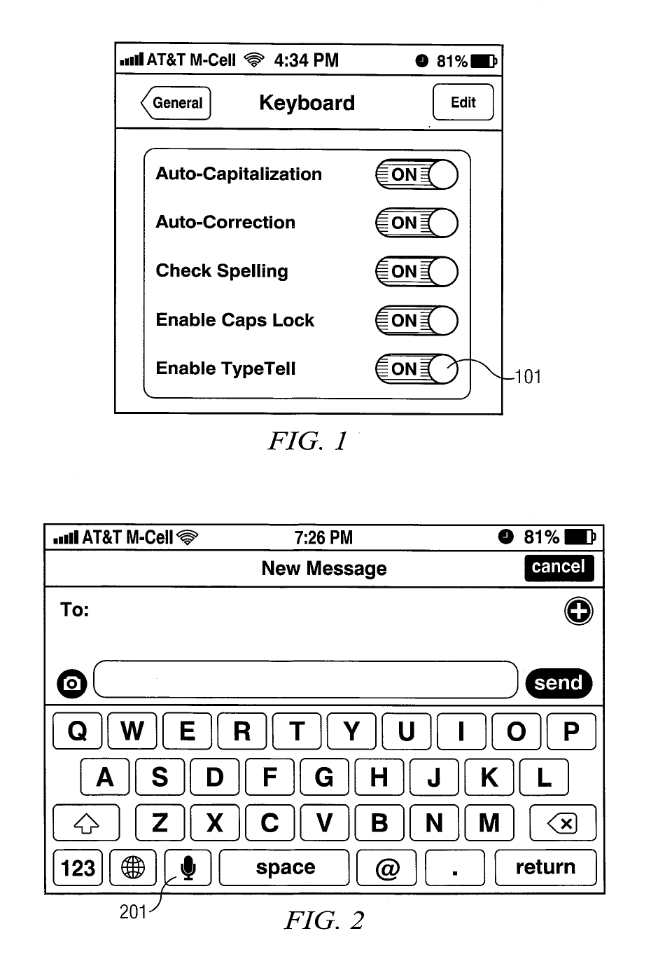

FIG. 1 is a representation of a screen on an Apple iPhone. In FIG. 1, the user has accessed the Keyboard preferences menu available under “Settings” from the phone's main menu. The TypeTell software has added a menu item “Enable TypeTell”. The user may enable the TypeTell functionality on the phone by swiping the corresponding on/off switch 101 to “on” (such swipe functionality being conventional in iPhone operations).

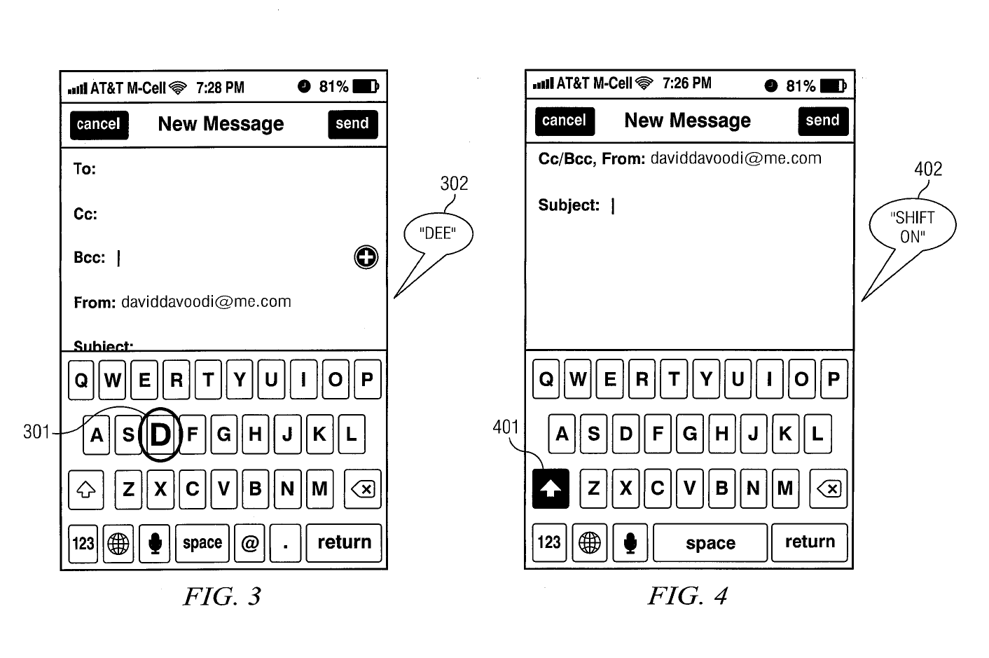

Referring now to FIG. 2, it will be understood that the iPhone user has enabled the TypeTell functionality per FIG. 1 and has now brought up the text messaging function on the iPhone, per conventional iPhone operations. FIG. 2 is a representation of the “New Message” screen, where the cursor is located in the “To:” field, poised to display data keystroked by the user. The iPhone's touch-screen keyboard is displayed in the lower half of the screen and awaits touch keystrokes from the user.

FIG. 2 further illustrates the voice dictation activate/deactivate key 201, as found on conventional iPhone keyboards. It will be understood, although not illustrated, that when TypeTell functionality has been enabled (for example, as described above in association with FIG. 1), the voice dictation activate/deactivate key 201 may no longer be needed. The TypeTell software may thus replace the icon on key 201 with a “TypeTell mute/unmute” icon, and use key 201, when stroked, to mute and unmute the TypeTell keystroke announcer functionality without the user having to return to the Keyboard preferences menu to disable the TypeTell function (per FIG. 1). When the user does disable the TypeTell function (per FIG. 1), then key 201 on FIG. 2 may be returned to voice dictation functionality.

Alternatively, instead of substituting TypeTell mute/unmute functionality for voice dictation activate/deactivate functionality on key 201 on FIG. 2, the TypeTell software may cause a new TypeTell mute/unmute key to appear on the touch-screen keyboard when TypeTell functionality is enabled. Just for example, the new key may be located on the right of the “space” key, causing the “space” key to be smaller in size while the TypeTell functionality is enabled and the TypeTell key is present. The TypeTell key may then disappear (and the “space” key may return again to its original size) when the user disables TypeTell functionality.

It will be understood, however, that such location next to the “space” bar would be exemplary only, and that in other embodiments the TypeTell key may be located elsewhere. This disclosure is not limited in this regard. Moreover, the TypeTell key, when present, may be characterized by any icon or identifier, and this disclosure is further not limited in this regard.

In FIG. 3, the user has tapped the “Bcc” field, and the cursor has moved to that location. Consistent with conventional iPhone operations, the cursor is poised to display data keystroked into that field by the user. The iPhone's touch-screen keyboard continues to be displayed in the lower half of the screen. It will also be seen on FIG. 3 that in moving from in status from FIG. 2 to FIG. 3, the user has rotated the iPhone from landscape view to portrait view.

With further reference to FIG. 3, highlighted “D” key 301 represents that the user is momentarily about to touch the “D” key. Speaking icon 301 represents that as the user makes the “D” keystroke (or very shortly thereafter) the TypeTell software causes the iPhone to announce the keystroke by audibly speaking “Dee”.

Referring now to FIG. 4, it will be understood (although not illustrated in detail) that the user completed data entry into the “Bcc:” field with the following keystrokes:

d-a-v-i-d-d-a-v-o-o-d-i-@-m-e-.-c-o-m

and the TypeTell software announced, on the fly, as (or shortly after) each individual keystroke was made, as follows:

Dee-Ay-Vee-Eye-Dee-Dee-Ay-Vee-Oh-Oh-Dee-Eye-At-Em-Eee-Dot-See-Oh-Em

In this way, it will be appreciated that the TypeTell software causes the iPhone to announce keystrokes “on the fly”, as (or very shortly after) each individual keystroke is made, in any application executable on the iPhone in which a touch-screen keyboard may be used for data entry. “On the fly” refers to a response time from the iPhone in real time, (i.e., as the iPhone processes the touched keystrokes and responds with the corresponding announcement, without delay). Such applications of course include frequently used applications such as messaging, email, and internet browsing. However, the scope of this disclosure is expressly not limited to such frequently used applications.

FIG. 4 further illustrates that the TypeTell keystroke announcing feature is not limited to alphanumeric keystrokes or keystrokes that may actually show a discernable result at the cursor. In FIG. 4, highlight shift key 401 represents that the user is momentarily about to touch the “shift” key. Speaking icon 401 represents that as the user makes the “shift” keystroke (or very shortly thereafter) the TypeTell software causes the iPhone to announce the keystroke by audibly speaking “Shift On”.

Of course, this disclosure is not limited to any particular selection of announcement for a non-alphanumeric key like the shift key 401 on FIG. 4. Other embodiments might cause the iPhone to announce “Cap On” or some other utterance. The point is that TypeTell is operable to announce all keystrokes (alphanumeric or otherwise) available to the user on any particular keyboard, using a unique announcement for each key that will enable the user to audibly confirm that the desired keystroke was actually made.

Those of ordinary skill in the computer programming field will understand appreciate that the TypeTell functionality described and envisaged in this disclosure may be enabled by conventional software suitable to be executed on the particular computing device upon which the functionality is deployed. More specifically, it will be appreciated that the TypeTell software described in this disclosure may be embodied in the form of computer-executable instructions stored in non-transitory, persistent storage on a computer-readable storage medium. The computer-executable instructions may comprise routines configured to be executed by a general-purpose data processor, such as is conventionally found in smart phones, tablet computers, and other computing devices having touch-sensitive screens. The scope of the TypeTell functionality described in this disclosure is not limited to smart phones or tablet computers, however, and will be understood to be operable on any computing device having a touch-sensitive screen. For the avoidance of doubt, it will be appreciated that the TypeTell functionality described in this disclosure may be practiced on all manner of communications, data processing, or computer system configurations with touch-sensitive screens, including (without limitation): wireless devices, Internet appliances, hand-held devices (including personal digital assistants (“PDA”s)), wearable computers, all manner of cellular or mobile phones, multi-processor systems, microprocessor-based or programmable consumer electronics, set-top boxes, network PCs, tablet and notebook computers, laptop and desktop computers, mini-computers, mainframe computers, and the like.

### Alternative Embodiments

As noted above, the TypeTell software and functionality has been disclosed herein using the illustrative example of an Apple iPhone. However, also as noted, the TypeTell software and functionality may be deployed on any computing device with a touch-sensitive screen and a capability to make audible announcements. Further alternative embodiments follow.

The TypeTell software may also be configured to recognize when other software on the computing device has made automatic corrections to or supplementation to keystrokes, such as automatic spell correction or capitalization correction. In cases of such automatic keystroke correction, the software may announce the corrected or supplemented keystrokes as opposed to the keystrokes made by the user. Alternatively, the software may announce the keystrokes made by the user, followed by announcement, for example, such as “Corrected”, and then the automatic corrections or supplements.

The TypeTell software may also be configured to make keystroke announcements by a user-selectable variety of voices, such as (purely for example) male, female, child, or robotic.

The TypeTell software may also be configured without the mute/unmute key function described above with reference to FIG. 2.

The TypeTell software may also be configured to announce other keystroke actions on a touch-sensitive screen, away from the keyboard. For example, on FIG. 2, as noted above, the user has located the cursor in the “To:” field by tapping on the field as displayed on the screen. The TypeTell software may be configured to announce “To”, or some other appropriate utterance, when the user makes this selection.

The TypeTell software may also be configured to recognize, via keystroking context, the correct keystroke announcement required when the user makes keystrokes that may have different audible utterances in different situations. For example, stroking the “dot” key might sometimes call for a “dot” utterance (such as if the user was typing an email address), and at other times call for a “period” utterance (such as at the end of a typed sentence). This opportunity for further sophistication of the TypeTell software in regard to use of the “dot” key is exemplary only, and again this disclosure is not limited in this regard.

Although the inventive material in this disclosure has been described in detail along with some of its technical advantages, it will be understood that various changes, substitutions and alternations may be made to the detailed embodiments without departing from the broader spirit and scope of such inventive material as set forth in the following claims.

1. A set of computer-executable instructions suitable to be persistently stored on a non-transitory computer-readable storage medium, the set of instructions, when executed, causing a computer processor programmed by said set of instructions to perform a method, the computer processor further running an operating system, the computer processor further instructed via a user interface that includes a touch-sensitive screen, the method comprising the steps of:
(a) receiving information that a uniquely-identifiable zone on the touch-sensitive screen has been activated via a single touch tap, the touch tap recognized by the computer processor as a keystroke corresponding to the uniquely-identifiable zone on the touch-sensitive screen;
(b) responsive to the single touch tap in step (a), executing a function corresponding to the keystroke in run mode;
(c) matching the uniquely-identifiable zone to a designated audible response previously associated therewith; and
(d) causing a sound media player to announce the designated audible response in real time with step (a).

2. The set of computer-executable instructions of claim 1, in which the uniquely-identifiable zone is about 4 mm by about 6 mm in touchable screen area.

3. The set of computer-executable instructions of claim 1, in which the method further comprises the step of:
(e) repeating steps (a) through (d) in response to a series of activations, via touches, of uniquely-identifiable zones on the touch-sensitive screen.

4. The set of computer-executable instructions of claim 1, in which the uniquely-identifiable zone is selected from the group consisting of:
(1) a key on a screen keyboard;
(2) a icon on the touch-sensitive screen, activation of which causes the computer processor to execute software instructions corresponding to the icon; and
(3) an area on the touch-sensitive screen of specific interest to a user.

5. The set of computer-executable instructions of claim 3, in which the method further comprises the steps of:
(f) comparing, in real time as activations are made in step (a), a concatenation of said activations to a stored population of acceptable activation strings;
(g) correcting, according to a statistically-based correction algorithm, the concatenation of activations in step (f) if said concatenation is not found in the stored population of acceptable activation strings; and
(h) causing the sound media player to announce an audible utterance corresponding to the correction in step (g) in real time.

6. The set of computer-executable instructions of claim 1, in which said set of computer-executable instructions are embedded in the operating system.

7. The set of computer-executable instructions of claim 1, in which said set of computer executable instructions are initially provided to the computer processor via a communications download.

8. A set of computer-executable instructions suitable to be persistently stored on a non-transitory computer-readable storage medium, the set of instructions, when executed, causing a computer processor programmed by said set of instructions to perform a method, the computer processor running an operating system, the computer processor further instructed via a user interface that includes a touch-sensitive screen, the method comprising the steps of:
(a) receiving information that a uniquely-identifiable zone on the touch-sensitive screen has been activated via a single touch tap;
(b) recognizing the uniquely-identifiable zone as a key on a screen keyboard on the touch-sensitive screen;
(c) responsive to the single touch tap in step (a), executing a keystroke corresponding to the key recognized in step (b) in run mode;
(d) matching the key to a designated audible response previously associated with the key, the designated audible response comprising an announcement of the key according to a pre-ordained keyboard convention;
(e) causing a sound media player to announce the designated audible response in real time with step (a).

9. The set of computer-executable instructions of claim 8, in which the uniquely-identifiable zone is about 4 mm by about 6 mm in touchable screen area.

10. The set of computer-executable instructions of claim 8, in which the method further comprises the step of:
(f) repeating steps (a) through (e) in response to a series of activations, via touches, of uniquely-identifiable zones on the touch-sensitive screen

11. The set of computer-executable instructions of claim 8, in which the pre-ordained keyboard convention corresponds to a human-readable language.

12. The set of computer-executable instructions of claim 8, in which the pre-ordained keyboard convention corresponds to one of a plurality of keyboard conventions within a single human-readable language.

13. The set of computer-executable instructions of claim 10, in which the method further comprises the steps of:
(g) comparing, in real time as activations are made in step (a), a concatenation of said activations to a stored population of acceptable activation strings;
(h) correcting, according to a statistically-based correction algorithm, the concatenation of activations in step (g) if said concatenation is not found in the stored population of acceptable activation strings; and
(i) causing the sound media player to announce an audible utterance corresponding to the correction in step (h) in real time.

14. The set of computer-executable instructions of claim 8, in which said set of computer-executable instructions are embedded in the operating system.

15. The set of computer-executable instructions of claim 8, in which said set of computer executable instructions are initially provided to the computer processor via a communications download.

16. A method for validating a touch made on a touch-sensitive screen, the method comprising the steps of:
(a) providing a touch-sensitive screen in communication with a computing device, wherein single touch taps on uniquely-identifiable zones on the screen are configured to cause the computing device to execute corresponding functions in run mode;
(b) intending to make a single touch tap on an intended uniquely-identifiable zone on the screen;
(c) making a single touch tap on an actually-touched uniquely-identifiable zone on the screen;
(d) responsive to step (c), causing the computing device to execute a function in run mode corresponding to the actually-touched uniquely-identifiable zone;
(e) hearing an audible response initiated by the computing device in real time with step (c) corresponding to the actually-touched uniquely-identifiable zone; and
(f) validating that the audible response corresponds to the intended uniquely-identifiable zone.

17. The method of claim 16, in which the intended uniquely-identifiable zone and the actually-touched uniquely-identifiable zone are both about 4 mm by about 6 mm in touchable screen area.

18. The method of claim 16, further comprising the steps of:
(g) repeating steps (a) through (f) in a series of cycles thereof.

19. The method of claim 16, in which the intended and actually-touched uniquely-identifiable zones are selected from the group consisting of:
(1) a key on a screen keyboard;
(2) a icon on the touch-sensitive screen, activation of which causes the computing device to execute a program corresponding to the icon; and
(3) an area on the touch-sensitive screen of specific interest to a user.
